(19) United States
(12) Patent Application Publication
(10) Pub. No.: US 2005/0007395 A1
(43) Pub. Date: Jan. 13, 2005

(54) METHOD FOR TRANSMITTING DISPLAY DATA

(76) Inventor: Ming-Che Tan, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/710,342

(22) Filed: Jul. 2, 2004

(30) Foreign Application Priority Data
Jul. 9, 2003 (TW) 092118755

(51) Int. Cl. G09G 5/10; G09G 5/02

(52) U.S. Cl. 345/691; 345/698; 345/699

(57) ABSTRACT

The invention provides a method for transmitting display data between an electronic apparatus and a display. The electronic apparatus includes a display circuit, a first and a second memory block. The display device includes a third memory block. The method (a) connects the display device to the electronic apparatus, (b) the display device transmits first display parameters to the electronic apparatus and stores the first display parameters into the first memory block, (c) compares the first and second display parameters (d) forms a third parameters according to the comparison of the first and the second display parameters in step (c) and stores the third parameters into the second memory block, (e) transmits the third display parameters from the electronic apparatus to the display device and stores this into the third memory block, and (f) displays images according to the display parameters stored in the third memory block by the display device.

### BACKGROUND OF INVENTION

1. Field of the Invention

The present invention relates to a method for transmitting display data between an electronic apparatus and a display device, and more specifically, to a method for transmitting display data by comparing display data between an electronic apparatus and a display device at first.

2. Description of the Prior Art

In the progress of computer multimedia technology, display devices and video cards play an important role. In order to conform to the plug and play (PNP) standard, data transmission between a display device and a video card generally relies on the display data channels (DDC), that is, the display device transmits its hardware parameters to the video card so that the video card can drive the display device. As different video cards have different settings for display modes and display devices, the compatibility between video cards and display devices becomes a problem. For instance, a computer application program uses a built-in command in the basic input/output system (BIOS) of a video card to establish an interface between the application program and the video card. In some video cards, the built-in command in the BIOS may not be the same, so that the application program may not be applied in certain video cards. Therefore, Video Electronic Standards Association (VESA) established a VESA BIOS extension (VBE) to unify the built-in commands of video cards.

DDC is also defined by VESA. This is an interface between the display device and the video card conforming to the PNP standard, so that a user does not need to install a driver program. DDC divides signals into serial data (SDA) and serial clock (SCL), wherein SDA represents internal parameters of a display device such as name, serial number, resolution and color, and SCL is a synchronous clock of SDA. One important structure of DDC is accomplished by SDA and SCL. DDC can be divided into DDC1 and DDC2B, wherein DDC1 provides a unidirectional transmission for an operating system or an application program to read parameters corresponding to hardware standards of a display device through a video card supporting DDC1. DDC2B provides a bi-directional transmission faster than DDC1 that can be used to control a monitor by an application program, hence replacing the function buttons on the monitor itself. In order to fulfill the requirements of PNP in Windows™, most monitors support DDC1 and DDC2B.

Please refer to FIG. 1 showing a data structure of conventional DDC, and FIG. 2 showing a flowchart of the operation of the conventional DDC. As shown in FIG. 1, the DDC parameters use 128-byte memory area. The parameters include system data 10, timing requirements 12 and format description 14. The system data 10 includes name and serial number etc., the timing requirement 12 includes a horizontal scanning frequency, vertical refreshing frequency, resolution, color gray level etc., and the format description 14 includes annotations of parameters and functions. As shown in FIG. 2, the operation of the conventional DDC is as follows:

Step110: Connects a display device to a video card in a computer of a computer system;

Step120: The video card reads display parameters of the display device through DDC;

Step130: The computer judges whether the display device is new to the computer system. If the answer is ‘yes’, it proceeds to Step140, if the answer is ‘no’, the display data of the display device already exists in the computer system. It proceeds to Step150;

Step140: Adds the display parameters of the display device, i.e. system data, timing requirements and format description into a database of the computer system;

Step150: Finishes the settings of the display data of the display device.

As described above, the conventional DDC adds display parameters of a display device into a database of a computer. The computer can drive the display device quickly in order to fulfill any PNP requirements. Further calculation is needed as the display device operates according to the display parameters. If the display device does not support the display parameters of the video card, it cannot display images properly.

### SUMMARY OF INVENTION

It is therefore a primary objective of the present invention to provide a method for transmitting display parameters between an electronic apparatus and a display device to solve the problems mentioned above.

Briefly summarized, the present invention provides a method for transmitting display parameters between an electronic apparatus and a display device. The electronic apparatus includes a display circuit, a first memory block, and a second memory block. The display device includes a third memory block. The method comprises the following steps: (a) connecting the display device to the electronic apparatus, (b) transmitting first display parameters from the display device to the electronic apparatus and storing the first display parameters in the first memory block, (c) comparing the first display parameters and second display parameters which predetermined by the display circuit, (d) forming third display parameters according to the comparison of the first display parameters and the second display parameters in step (c) and storing the third display parameters into the second memory block, (e) transmitting the third display parameters from the electronic apparatus to the display device and storing the third display parameters into the third memory block, and (f) displaying images according to the display parameters stored in the third memory block by the display device.

The present invention also provides a second method for transmitting display parameters between an electronic apparatus and a display device. Wherein, the electronic apparatus includes a display circuit and predetermined first display parameters, and the display device comprises second display parameters. The method includes the following steps: (a) connecting the display device to the electronic apparatus, (b) transmitting the second display parameters from the display device to the electronic apparatus, (c) comparing the first display parameters with the second display parameters in the electronic apparatus, (d) forming third display parameters according to the comparison of the first display parameters and the second display parameters in step (c), (e) transmitting the third display parameters from the electronic apparatus to the display device, and (f) displaying images according to the display parameters by the display device.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a data structure of conventional DDC.

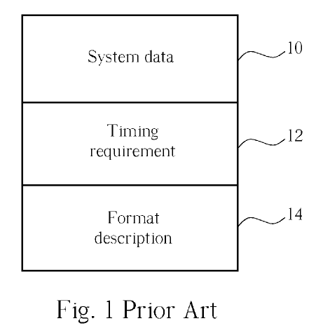

FIG. 2 is a flowchart of the operation of the conventional DDC.

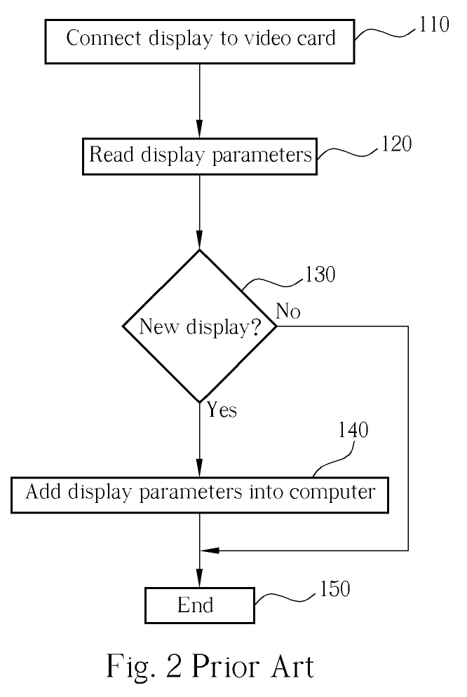

FIG. 3 illustrates a parameters structure of DDC according to the present invention.

FIG. 4 illustrates the format of each timing information.

FIG. 5 is a flowchart of the operation of the DDC according to the present invention.

### DETAILED DESCRIPTION

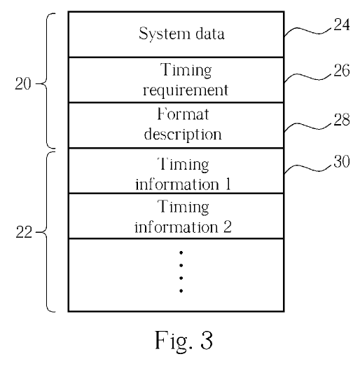

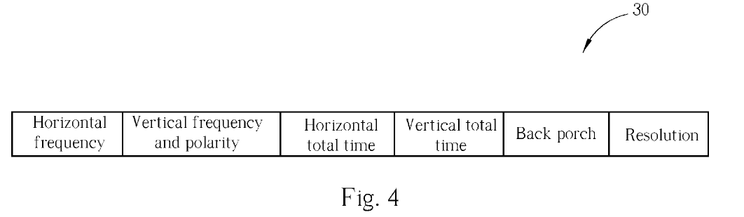

FIG. 3 shows a DDC data structure and FIG. 4 shows the timing format. Besides conventional system data, timing requirements and format descriptions, in the DDC data structure another 128-byte memory area is dedicated to store groups of timing information. As shown in FIG. 3, a computer (not shown) includes a first memory block 20 and a second memory block 22 using a 128-byte memory area. The first memory block 20 stores system data 24, timing requirement 26 and format description 28, and the second memory block 22 stores a plurality of groups of timing information 30. When a new display device is connected to the video card of the computer, the display parameters of the display device is transmitted to the computer through the DDC. The computer saves the display parameters into the first memory block 20. The display parameters includes the system data 24, the timing requirement 26 and the format description 28. This provides the computer with enough instructions to drive the display device. The display device operates according to the display parameters of the video card. The computer reads the display parameters of the video card after establishing the display parameters of the display device in the first memory block 20. The computer then compares the display parameters of the video card with the display parameters of the display device. It then selects the timing information supported by the display device and the video card in order to build the plurality of groups of timing information 30 and store them into the second memory block 22. Then, the display device can read the timing information 30 directly from the second memory block 22 and copy the timing information 30 to a predetermined timing information area of the display device for the display device to operate. As shown in FIG. 4, each group of timing information includes parameters such as horizontal frequency, vertical frequency and polarity, horizontal total time, vertical total time, back porch and resolution, and uses a 16-byte memory area so that eight groups of the timing information 30 can be stored in the second memory block 22.

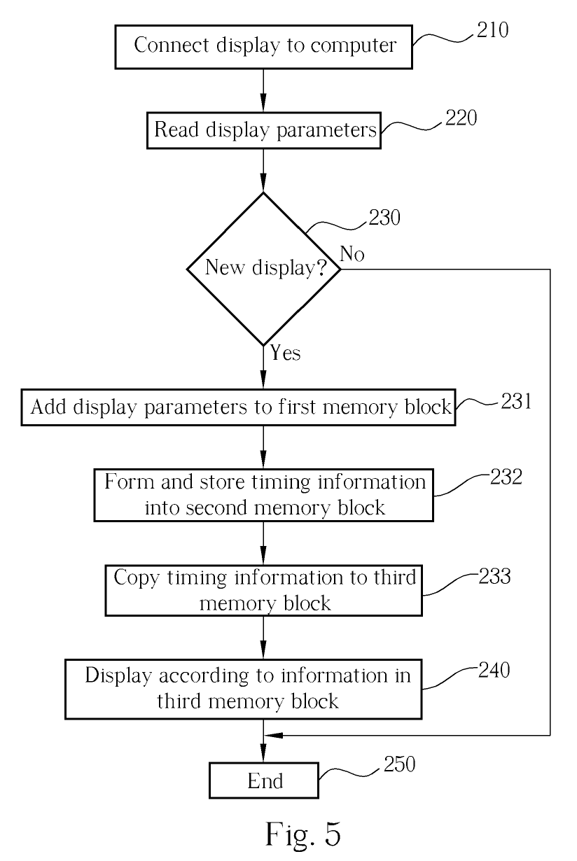

Please refer to FIG. 5: Shown is a flowchart of the present operation of the DDC. The DDC operates in a computer system. The computer system consists of a computer with a video card and a display device with a first, second and third memory block. The operation of the DDC is as follows:

Step210: Connect the display device to the computer by using a DDC transmission line to connect the display device to the video card in the computer;

Step220: The video card reads the display parameters of the display device through the DDC;

Step230: The computer decides whether the display device is new to the computer system. If the answer is ‘yes’, it proceeds to Step231, if the answer is ‘no’ and the display parameters of the display device already exists, it proceeds to Step250;

Step231: Adds display parameters of the display device such as system data, timing requirements and format description into the first memory block of the computer;

Step232: The computer compares the display parameters of the video card with the parameters of the display device to select timing information supported both by the display device and the video card to form the plurality of groups of timing information and store them into the second memory block;

Step233: The computer transmits the plurality of groups of timing information stored in the second memory block to the display device and the display device stores the plurality of groups of timing information into the third memory block;

Step240: Display images according to the timing information stored in the third memory block by the display device;

Step250: Finish the display parameters settings between the computer and the display device.

The DDC firstly compares the difference between the display parameters supported by the display device and the video card. Then it selects the display parameters both supported by the display device and the video card to form the plurality of groups of timing information 30. Using this method, the display device can display images directly. The plurality of groups of timing information 30 is provided both by the display device and the video card. According to the timing information the display device can display images correctly. In summary, the present invention provides a method for transmitting display parameters between an electronic apparatus and a display device. The electronic apparatus includes a display circuit and predetermined first display parameters, and the display device includes second display parameters. When the display device is connected to the electronic apparatus, the display device transmits the second display parameters to the electronic apparatus, which the electronic apparatus compares. The first and the second display parameters form the third display parameters. Eventually the third display parameters is transmitted to the display device so that the display device can display it in accordance with the third display parameters.

In contrast to the prior art, when a display device is connected to a video card, the DDC according to the present invention combines the display parameters of the display device and the video card to form the timing information supported by both devices, so that the display device can display images correctly. This also reduces calculations in the display device. Although the timing information requires additional memory, the required extra memory is small and low in cost. In the prior art, timing information supported by a display device and a video card is not combined so that further calculation before displaying is needed, otherwise the display device cannot display images correctly.

Those familiar with the prior art will observe that numerous modifications and alterations of the prior method were made while still retaining the teachings of the invention. Accordingly, the above disclosure should be construed as limited only by the metes and bounds of the appended claims.

1. A method for transmitting display parameters between an electronic apparatus and a display device, the electronic apparatus comprising a display circuit, a first memory block, and a second memory block, the display device comprising a third memory block, the method comprising:
(a) connecting the display device to the electronic apparatus;
(b) transmitting first display parameters from the display device to the electronic apparatus and storing the first display parameters in the first memory block;
(c) comparing the first display parameters and second display parameters predetermined by the display circuit;
(d) forming third display parameters according to the comparison of the first display parameters and the second display parameters in step (c) and storing the third display parameters in the second memory block;
(e) transmitting the third display parameters from the electronic apparatus to the display device and storing the third display parameters in the third memory block; and
(f) displaying images according to the display parameters stored in the third memory block by the display device.

2. The method of claim 1 wherein steps (a) to (f) are executed only when the first display parameters are not founded in the first memory block.

3. The method of claim 1 wherein the first memory block, the second memory block, and the third memory block are 128 bytes in size.

4. The method of claim 1 wherein the first display parameters, the second display parameters, and the third display parameters comprise resolution, scanning frequency, and color features.

5. The method of claim 4 wherein steps (c) to (d) compare resolution, scanning frequency, and color features of the first display parameters and the second display parameters to form the third display parameters.

6. The method of claim 1 wherein the first display parameters, the second display parameters, and the third display parameters comprise a first clock, a second clock, and a third clock respectively for signal synchronizing, and step (c) and step (d) compare the first clock with the second clock to form the third clock.

7. A method for transmitting display parameters between an electronic apparatus and a display device, the electronic apparatus comprising a display circuit and predetermined a first display parameters, the display device comprising a second display data, the method comprising:
(a) connecting the display device to the electronic apparatus;
(b) transmitting the second display parameters from the display device to the electronic apparatus;
(c) comparing the first display parameters with the second display data in the electronic apparatus;
(d) forming a third display parameters according to the comparison of the first display parameters and the second display parameters in step (c);
(e) transmitting the third display parameters from the electronic apparatus to the display device; and
(f) displaying images according to the third display parameters by the display device.

8. The method of claim 7 wherein the first display parameters, the second display parameters, and the third display parameters comprise a first clock, a second clock, and a third clock respectively for signal synchronizing, and step (c) and step (d) compare the first clock with the second clock to form the third clock.

9. The method of claim 7 wherein the first display parameters, the second display parameters, and the third display parameters comprise resolution, scanning frequency and color features.

10. The method of claim 9 wherein steps (c) to (d) compare resolution, scanning frequency, and color features of the first display parameters and the second display parameters to form the third display data.
